(19) United States
(12) Patent Application Publication
(10) Pub. No.: US 2012/0210685 A1
(43) Pub. Date: Aug. 23, 2012

(54) APPARATUS OF CENTRIFUGAL FAN AND A DUST-COLLECTING MODULE USING THE SAME

(75) Inventors: YANN-SHUOH SUN, Taipei County (TW); Yu-Liang Chung, Taipei City (TW); Jiing-Fu Chen, Hsinchu City (TW); Tung-Chuan Wu, Hsinchu City (TW); Chun-Hsien Liu, Taipei City (TW)

(73) Assignee: Industrial Technology Research Institute, Hsin-Chu (TW)

(21) Appl. No.: 13/465,318

(22) Filed: May 7, 2012

Related U.S. Application Data
(63) Continuation-in-part of application No. 11/536,285, filed on Sep. 28, 2006.

(30) Foreign Application Priority Data
Sep. 15, 2006 (TW) 095134161

(51) Int. Cl. B01D 46/42

(52) U.S. Cl. 55/391

(57) ABSTRACT

A centrifugal fan apparatus is disclosed in the present invention. The characteristics of the centrifugal fan apparatus lies in that the width of airflow channel defined between the rim of the impeller and the inner wall of the housing accommodating the impeller is uniform, and two airflow spaces defined between the axial cross section of the impeller and upper housing and lower housing respectively are not symmetry. Due to these two characteristics, the centrifugal fan apparatus is capable of making larger pressure difference to inducing higher flow rate and reducing noise while the centrifugal fan apparatus is operated. The present invention also provides a dust-collecting module that is formed by adopting the centrifugal fan apparatus with a designed dust-collecting casing, which is capable of being a sucker of a vacuum cleaner to collect dust of the surroundings for the purpose of environment cleaning.

### CROSS REFERENCE TO RELATED PATENT APPLICATION

This application is a continuation-in-part of U.S. patent application Ser. No. 11/536,285 filed on Sep. 28, 2006.

### FIELD OF THE INVENTION

The present invention relates to a centrifugal fan apparatus, and more particularly, to a low noise, high flow rate centrifugal fan apparatus with asymmetry fan housing design, which has an uniform airflow channel formed between the rim of its impeller and its housing, and is applicable to a dust-collecting module.

### BACKGROUND OF THE INVENTION

An autonomous vacuum cleaner, being a fully automated cleaning device, is a renovating device different from those conventionally vacuum cleaners and other sweeping devices, that is can clean a specific area autonomously without any human attention and thus is foreseen to be the future cleaning device replacing those conventional manual-operated vacuum cleaners and other cleaning devices. After the operation mode is set, an autonomous vacuum cleaner is able to maneuver around obstacles while performing a ground cleaning operation, even cleaning those usually considered as the dead spots of cleaning

Although the autonomous vacuum cleaner is a great help to daily household cleaning, its function is limited by its power source, which is not an alternating current (AC) power source, and by its own interior space, which limited the same from adopting those air compressors used in those conventional vacuum cleaners. Therefore, as the autonomous vacuum cleaner only has limited power supply, a good centrifugal fan is essential for enabling the same to have good performance. Nonetheless, the centrifugal fan is beneficial for its operating noise is lower than those conventional air compressors.

It is noted that current design of a centrifugal fan is focusing on low noise, high pressure difference and large flow rate while maintaining smooth operation. One such design is disclosed in TW Pat. No. M246471, which shows a centrifugal fan device and a vacuum cleaner adopting the same. However, as the housing of the aforesaid centrifugal fan device is not improved while no proper deflector is available in the airflow channel, it is prone to generate noise. Another such design is disclosed in EPC Pat. No. EP0943808, in which its casing is designed for enabling its air pressure cavity to run spirally to an outflow aperture whereas its casing tongue is made with a through curvature for separating the airflow of the intake end from that of the outflow end so that the efficiency of the aforesaid centrifugal fan device can be improved as turbulence is avoided.

Generally, in those disclosed centrifugal fan devices, the convenience of attaching a dust-collecting box upon a centrifugal fan device is mostly cancelled out by the blocking of the smoothness of air flow in the centrifugal fan device's airflow channel.

Therefore, it is in need of an improved centrifugal fan apparatus and a dust-collecting module that are freed from the foregoing drawbacks.

### SUMMARY OF THE INVENTION

It is the primary object of the present invention to provide a low noise, high flow rate centrifugal fan apparatus with asymmetry fan housing design, which has an uniform airflow channel formed between the rim of its impeller and its housing, and is applicable to a dust-collecting module.

Another object of the invention is to provide a dust-collecting module capable of utilizing it specially designed casing to assemble a centrifugal fan apparatus of the invention so as to be able to perform a dust-collecting operation while maintaining the smoothness of airflow in the centrifugal fan apparatus.

To achieve the above objects, the present invention provides a centrifugal fan apparatus, comprising: a housing with an accommodating space, having an intake hole and an outflow hole; an impeller, arranging in the accommodating space while enabling an airflow channel of uniform width to be formed between a rim of the impeller and a side wall of the housing; and a driving device, connected to the impeller for driving the same to rotate.

Preferably, the accommodating space is divided into a first space and a second space by a virtual cross section passing the axial center of the impeller, referring as axial cross section hereinafter, whereas the first space is asymmetrical to the second space. Moreover, a helical airflow channel is extending from the second space and channeling to the outflow hole; and the sectional area of the helical airflow channel is increasing progressively from the beginning thereof to the outflow hole.

Preferably, the housing further is composed of: a top shell, having the intake hole formed thereon; and a bottom shell, having the outflow hole formed therein, being connected to the top shell.

Preferably, each blade used in the impeller is a blade selected from the group consisting of airfoil blades of signal-blade design and airfoil blades of dual-blade design.

In a preferred aspect, to achieve the above objects, the present invention provides a centrifugal fan apparatus, comprising: a housing with an accommodating space, having an intake hole and an outflow hole; an impeller, arranging in the accommodating space while enabling the accommodating space to be divided into a first space and a second space by a virtual cross section passing the axial center of the impeller, referring as axial cross section hereinafter, whereas the first space is asymmetrical to the second space; and a driving device, connected to the impeller for driving the same to rotate.

In addition, the present invention further provides a ducts-collecting module, comprising: a case, having a recess and a through hole channeling to the recess, and a side thereof being arranged with a groove hole channeling to the recess; a dust-collecting lid, connected to the groove hole; a box with a dust-collecting space, capable of being received in the recess for enabling the duct-collecting space to channel with the through hole and the groove hole; and a centrifugal fan apparatus, arranged upon the case, further comprising: a housing with an accommodating space formed therein, having an intake hole connected to the through hole and an outflow hole; an impeller, arranging in the accommodating space while enabling an airflow channel of uniform width to be formed between a rim of the impeller and a side wall of the housing; and a driving device, connected to the impeller for driving the same to rotate.

Preferably, a filtering device is arranged between the centrifugal fan apparatus and the through hole.

Preferably, the dust-collecting lid is further comprised of a roller with brush formed thereon.

Preferably, a plurality of sliding grooves are formed on two side walls of the recess for enabling a plurality of protrusions formed on two sides of the box, corresponding to the two side wall of the recess, to abut against thereupon and thus enabling the box to slide in and out the recess.

Yet, the present invention further provides a dust-collecting module, which comprises: a case, a case, having a recess and a through hole channeling to the recess, and a side thereof being arranged with a groove hole channeling to the recess; a dust-collecting lid, connected to the groove hole; a box with a dust-collecting space, capable of being received in the recess for enabling the duct-collecting space to channel with the through hole and the groove hole; and a centrifugal fan apparatus, arranged upon the case, further comprising: a housing with an accommodating space formed therein, having an intake hole connected to the through hole and an outflow hole; an impeller, an impeller, arranging in the accommodating space while enabling the accommodating space to be divided into a first space and a second space by a virtual cross section passing the axial center of the impeller, referring as axial cross section hereinafter, whereas the first space is asymmetrical to the second space; and a driving device, connected to the impeller for driving the same to rotate.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1A is an exploded diagram illustrating a centrifugal fan apparatus according to a preferred embodiment of the invention.

FIG. 1B is a schematic diagram showing a centrifugal fan apparatus of the invention.

FIG. 2A is a top view of an impeller having airfoil blades of signal-blade design according to the present invention.

FIG. 2B is a top view of an impeller having airfoil blades of dual-blade design according to the present invention.

FIG. 3A is a top view of a centrifugal fan apparatus according to the present invention.

FIG. 3B is a cross sectional view of a centrifugal fan apparatus according to the present invention.

FIG. 4 is a P-Q curve diagram illustrating the comparison between a centrifugal fan apparatus of the invention and other conventional centrifugal fan apparatuses.

FIG. 5 is a schematic diagram showing a dust-collecting module according to a preferred embodiment of the invention.

FIG. 6A is a schematic diagram showing a case of a ducts-collecting module according to a preferred embodiment of the invention.

FIG. 6B is an exploded diagram depicting a case of a ducts-collecting module according to a preferred embodiment of the invention.

FIG. 7 is a schematic diagram showing a dust-collect lid according to a preferred embodiment of the invention.

FIG. 8 is a side view of a second embodiment of a centrifugal fan apparatus according to the present invention.

FIG. 9 is a bottom view of a second embodiment of a centrifugal fan apparatus according to the present invention.

FIG. 10 is a schematic diagram showing a second of a dust-collecting module according to a preferred embodiment of the invention.

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

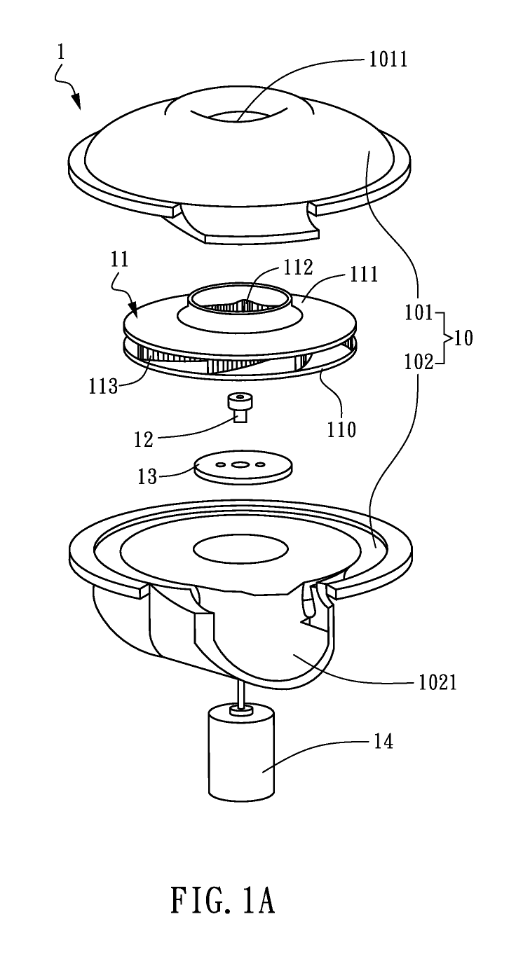

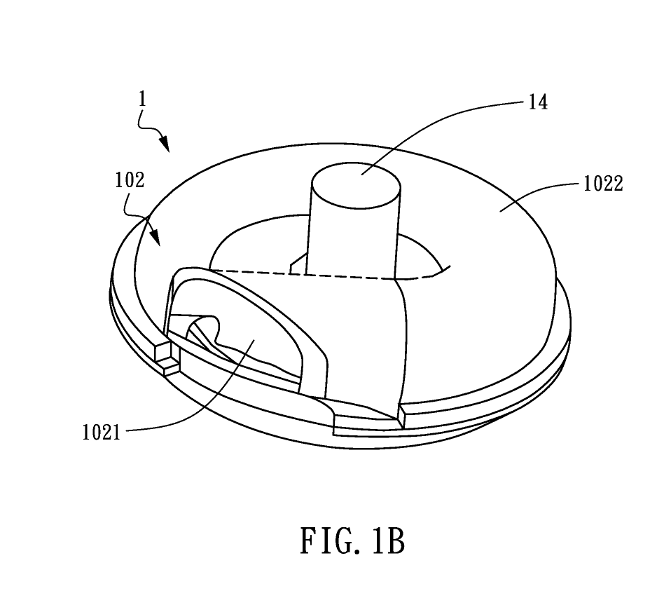

Please refer to FIG. 1A and FIG. 1B, which are respectively an exploded view and a pictorial view of a centrifugal fan apparatus according to a preferred embodiment of the invention. As seen in FIG. 1A and FIG. 1B, the centrifugal fan apparatus 1 is comprised of a housing 10, an impeller 11 and a driving device 14, in which the housing is further composed of a top shell 101 and a bottom shell 102. Apart from the helical casing, as that disclosed in EPC Pat. No. EP0943808, the axial cross section of an accommodating space formed by the assembling of the top shell 101 and the bottom shell 102 is shaped as a disc, which is different from those of prior arts, whereas an intake hole 1011 is formed at the center of the top shell 101; and an outflow hole 1021 is formed at a side of the bottom shell 102.

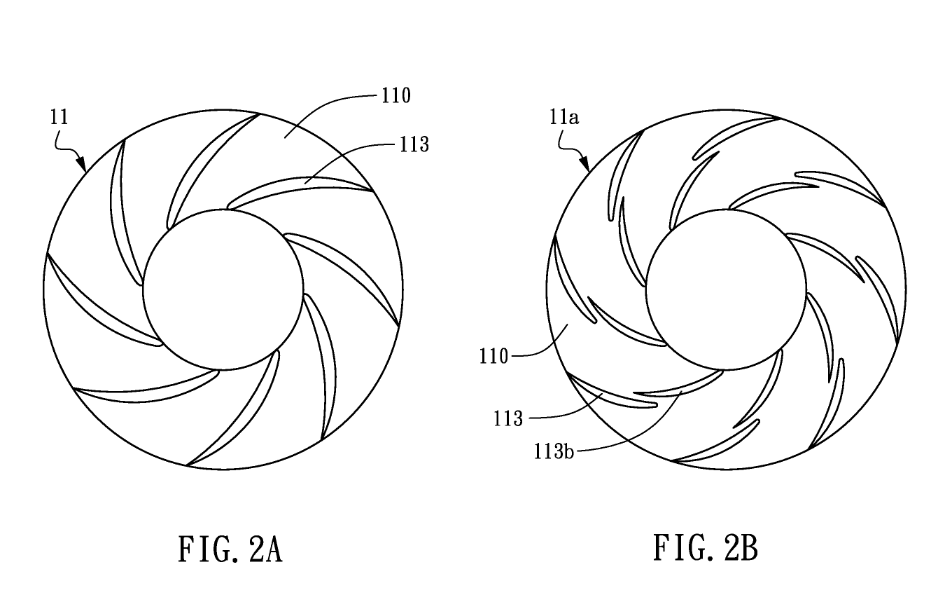

Moreover, the impeller 11 is disposed inside the accommodating space, which is composed of: a back panel 110; a plurality of blades 113, arranged on the back panel 110; and a top panel 112, arranged over the plural blades 113. The plural blades 113 can be arranged on the back panel 111 by manner as those illustrated in FIG. 2A and FIG. 2B. However, it is only used as illustration and is not limited thereby. In FIG. 2A, the plural blades 113 are radially arranged while each blade 113 used in the impeller 11 is an airfoil blade of signal-blade design. In FIG. 2B, the plural blades 113a, 113b are radially arranged while each blade used in the impeller l la are two offset airfoil blades 113a, 113b, i.e. blade of dual-blade design. In addition, the driving device 14 is connected to the impeller 11 by a pin 12 and an interfacing panel 13 so that the impeller 11 can be driven to rotate by the driving device 14.

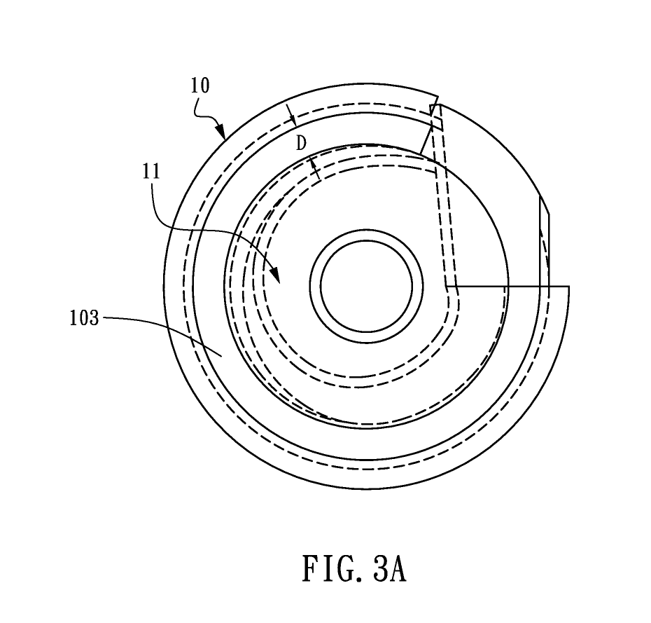

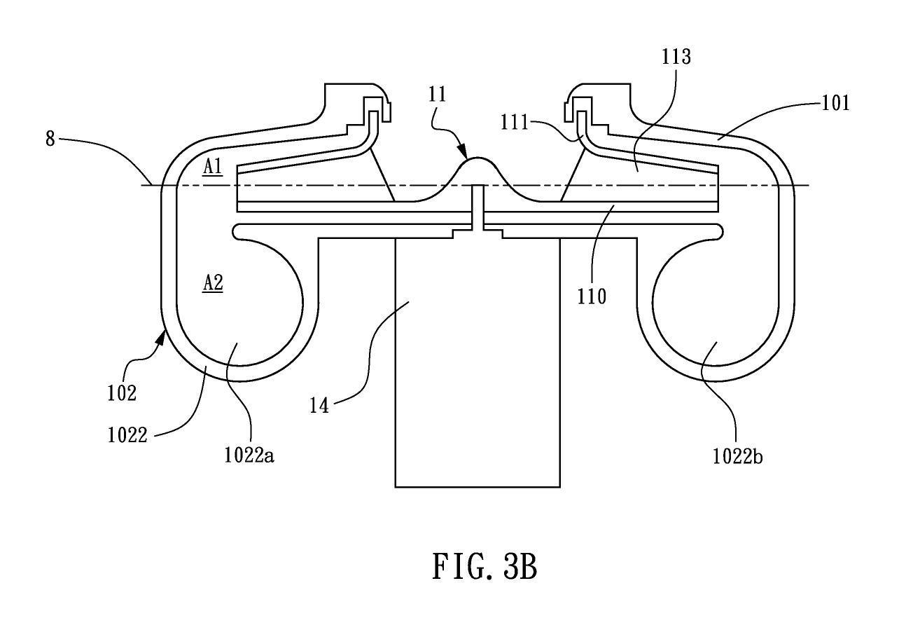

Please refer to FIG. 3A, which is a top view of a centrifugal fan apparatus according to the present invention. In FIG. 3A, the manner that the impeller 11 is being arranged inside the housing 10 is illustrated. As the axial cross section of the accommodating space of the housing 10 is shaped like a disc, an airflow channel 103 of uniform width D can be formed between a rim of the impeller 11 and a side wall of the housing 10. Please refer to FIG. 3B, which is a cross sectional view of a centrifugal fan apparatus according to the present invention. In FIG. 3B, the accommodating space is being divided into a first space A1 and a second space A2 by a virtual cross section 8 passing the axial center of the impeller 11 while enabling the first space A1 to be asymmetrical to the second space A2. As seen in FIG. 1B and FIG. 3B, a helical airflow channel 1022 is formed in the second space A2 by the bottom shell 102 whereas the sectional area of the helical airflow channel 1022 is increasing progressively from the beginning thereof to the outflow hole 1021. In FIG. 3B, two sections 1022a, 1022b are shown whereas the section 1022a is at a position near the outflow hole 1021 and the section 1022b is at a position near the beginning thereof, in which the area of the section 1022a is larger than that of the section 1022b.

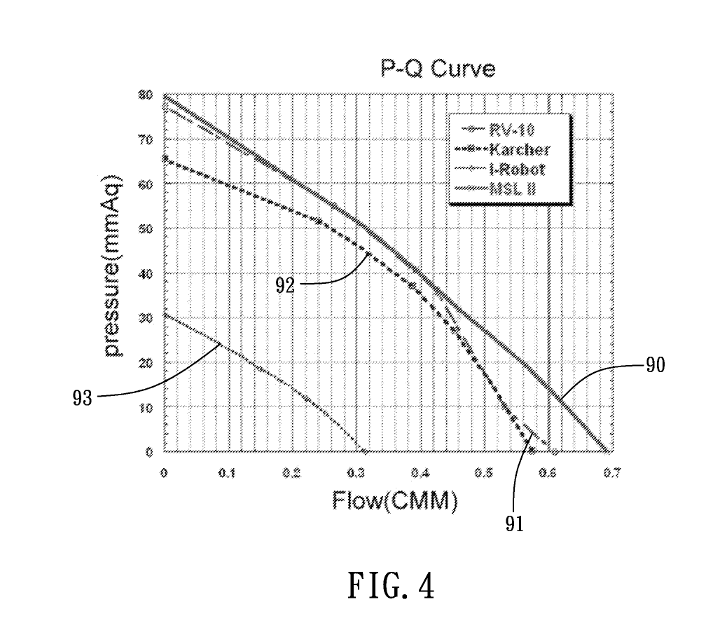

As there will be no obvious casing tongue by the housing design of the invention, most of the air flow will be discharged from the portion of the airflow channel under the impeller 11 so that no backflow will be generated between the intake and outflow and thus noise is reduced. Please refer to FIG. 4, which is a P-Q curve diagram illustrating the comparison between a centrifugal fan apparatus of the invention and other conventional centrifugal fan apparatuses. In FIG. 4, curve 90 represents the P-Q curve of a centrifugal fan apparatus of the invention, marked as MSL II; curve 91 represent the P-Q curve of a centrifugal fan apparatus disclosed in TW Pat. No. M246471, marked as RV-10; and curve 92 represent the P-Q curve of a centrifugal fan apparatus disclosed in EP0943808, marked as Karcher; and curve 93 represent the P-Q curve of a centrifugal fan apparatus of a current product, i.e. I-robot. As seen in FIG. 4, the performance of the centrifugal fan device of the invention is better than those other conventional centrifugal fan apparatuses, as the curve 90 is outperforming the curves 91, 92, 93. In addition, the overall noise of the invention is about the same as that of Karcher, but is much better than that of RV-10 by about 10dB. Hence, the centrifugal fan apparatus of the invention is considered to be a low noise, high flow rate centrifugal fan apparatus.

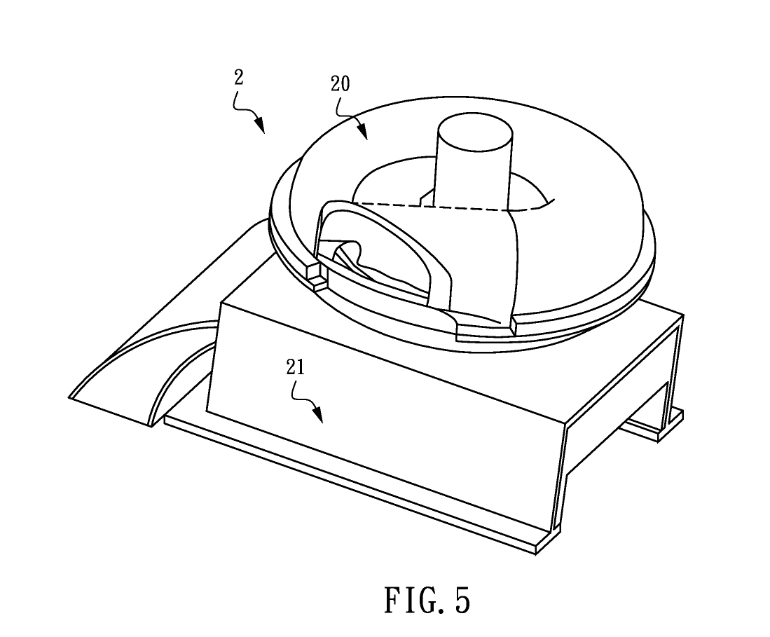

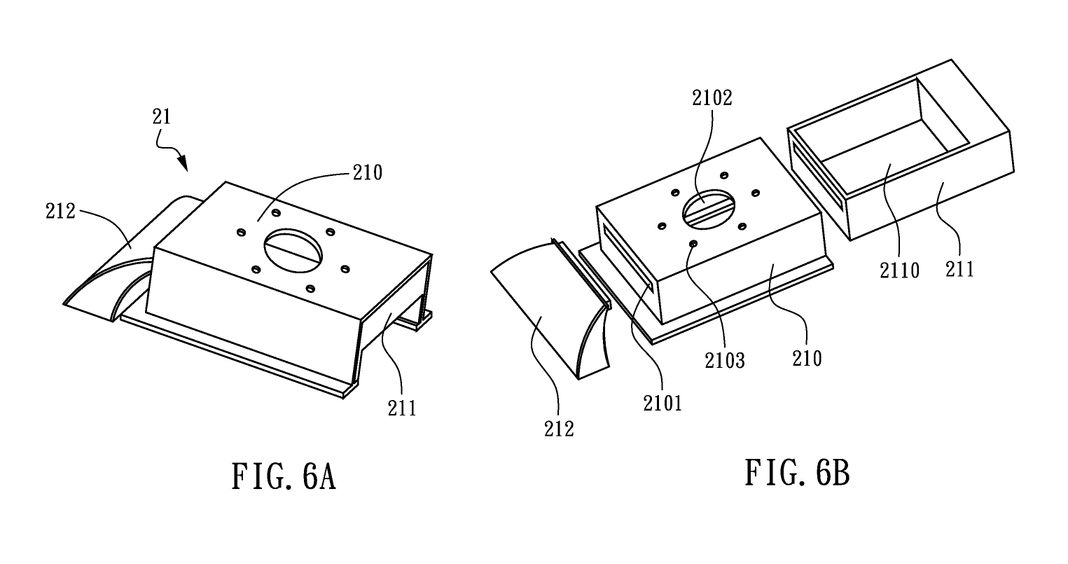

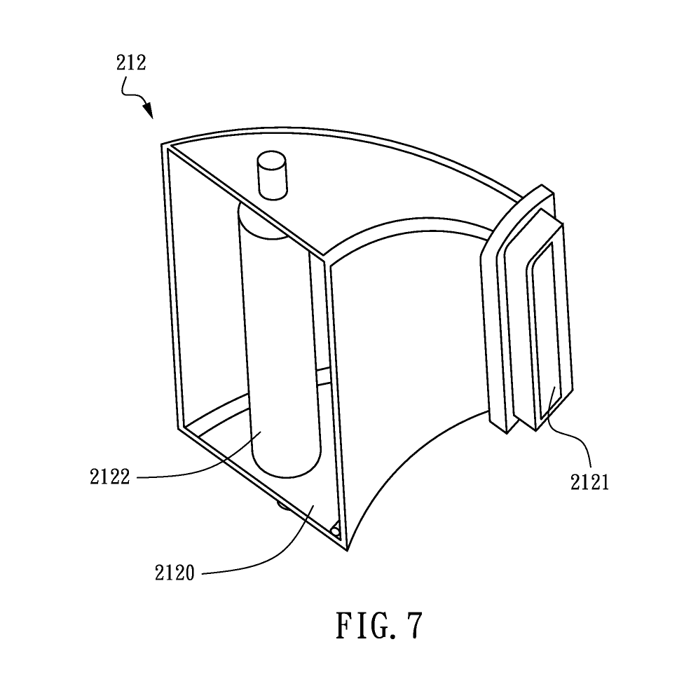

As the aforesaid centrifugal fan apparatus of the invention is capable of providing high flow rate while maintaining high pressure difference, the centrifugal fan apparatus is suitable to be adapted for a duct-collecting module. Please refer to FIG. 5, which is a schematic diagram showing a dust-collecting module according to a preferred embodiment of the invention. The duct-collecting module 2 is composed of a centrifugal fan apparatus 20 and a dust-collecting case 21, in which the centrifugal fan apparatus 20 can be the one disclosed hereinbefore. Please refer to FIG. 6A and FIG. 6B, which are respectively a schematic diagram and an exploded diagram showing a case of a ducts-collecting module according to a preferred embodiment of the invention. The ducts-collecting case 21 further comprises: a case 210, having a recess 2104 and a through hole 2101 channeling to the recess 2104; a dust-collecting lid 212; and a box 211; wherein, a side of the case 210 is arranged with a groove hole 2102 channeling to the recess 2104; the through hole is channeled to the intake hole of the centrifugal fan apparatus 20 while an extractable filtering device is arranged between the through hole 2102 and the centrifugal fan apparatus 20.

The box 211 is formed with a dust-collecting space 2110, which is capable of being received in the recess 2104 as a drawer while enabling the duct-collecting space to channel with the through hole 2102 and the groove hole 2101. By which, a duct-collecting bag received in the duct-collecting space can be easily accessed and replaced as the box 211 can be easily pulled out of the recess 2104. Please refer to FIG. 7, which is a schematic diagram showing a dust-collect lid according to a preferred embodiment of the invention. As seen in FIG. 7, an intake 2121 and an outflow 2120 are formed on the dust-collecting lid 212 while the intake 2121 is channeled with the groove hole 2101 of the case 210. In addition, a roller, preferred formed with brush, can be arranged at the intake 2121 of the dust-collecting lid 212.

In this preferred embodiment of the invention, for enabling air flow to flow smoothly in its airflow channel, the intake hole of its centrifugal fan apparatus is connected to the dust-collecting case 212 through the dust-collecting lid 212 while arranging the opening of the groove hole 2101 of the case 210 at a side thereof instead of at the bottom thereof, by which the airflow channel is not twist for the consideration of improving dust-collecting efficiency and thus noise is reduced. Moreover, as the case 210 and the box 211 are structured as a drawer that the box 211 can be pull out of the case easily, not only it is good for noise reduction, but also it is good for dust cleaning and filer replacing.

To sum up, the invention can provide a dust-collecting module capable of utilizing it specially designed casing to assemble a low noise, high flow rate centrifugal fan apparatus so as to be able to perform a dust-collecting operation while maintaining the smoothness of airflow in the centrifugal fan apparatus.

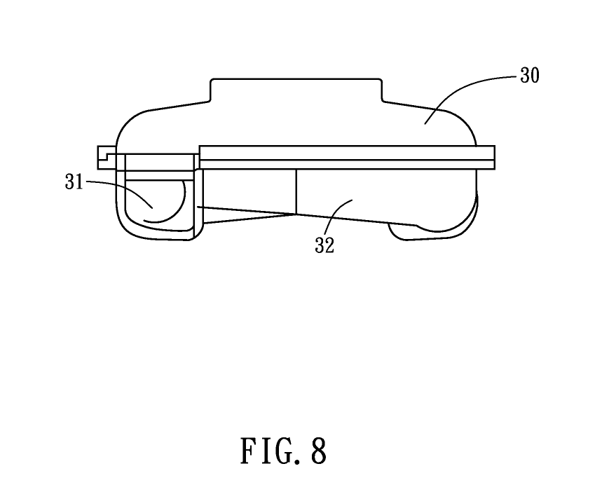

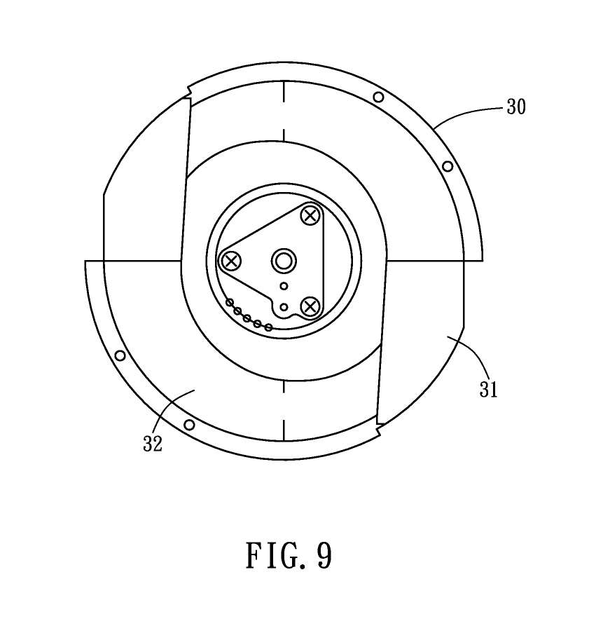

Please refer to FIG. 8, which is a side view of a second embodiment of a centrifugal fan apparatus according to the present invention. Please refer to FIG. 9, which is a bottom view of a second embodiment of a centrifugal fan apparatus according to the present invention. In FIG. 8 and FIG. 9, the centrifugal fan apparatus is similar to the centrifugal fan apparatus the disclosed in FIG. 1A and FIG. 1B. The difference is the housing 30 having two outflow holes 31 that are respectively formed at two side of the bottom shell 32 and corresponded to each other. The rest structures of the housing 30 in the FIG. 8 is the same as the housing 10 in the FIG. 1A.

In FIG. 9, the airflow of each outflow hole 31 is opposite to each other so that the housing 30 is able to keep balance when the airflow flows out of the housing 30. The advantage of two outflow holes 31 is centrifugal fan apparatus having higher flow rate and lower noise.

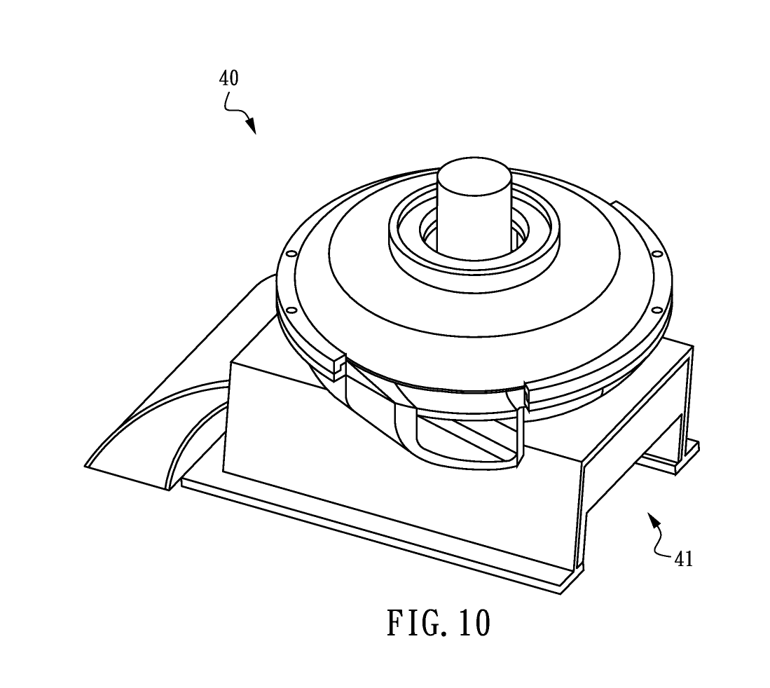

Please refer FIG. 10, which is a schematic diagram showing a second of a dust-collecting module according to a preferred embodiment of the invention. In FIG. 10, the dust-collecting case 41 is equal to the dust-collecting case 21 in the FIG. 5, 6A and 6B. The centrifugal fan apparatus 40 in FIG. 10 is equal to the centrifugal fan apparatus in the FIGS. 8 and 9. Due to the two outflow holes, the dust-collecting module in FIG. 10 has more efficacy of cleaning and the advantage of higher flow rate and lower noise.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A dust-collecting module, comprising:
a case, having a recess and a through hole channeling to the recess, and a side thereof being arranged with a groove hole channeling to the recess;
a dust-collecting lid, connected to the groove hole;
a box with a dust-collecting space, capable of being received in the recess for enabling the duct-collecting space to channel with the through hole and the groove hole; and
a centrifugal fan apparatus, arranged upon the case, further comprising:
a housing with an accommodating space formed therein, having an intake hole connected to the through hole and two outflow holes;
an impeller, arranging in the accommodating space while enabling an airflow channel of uniform width to be formed between a rim of the impeller and a side wall of the housing; and
a driving device, connected to the impeller for driving the same to rotate.

2. The dust-collecting module of claim 1, wherein the accommodating space is divided into a first space and a second space by a virtual cross section passing the axial center of the impeller while enabling the first space to be asymmetrical to the second space.

3. The dust-collecting module of claim 2, wherein a helical airflow channel is extending from the second space and channeling to the two outflow holes.

4. The dust-collecting module of claim 3, wherein the sectional area of the helical airflow channel is increasing progressively from the beginning thereof to the two outflow holes.

5. The dust-collecting module of claim 2, wherein the housing further is composed of:
a top shell, having the intake hole formed thereon; and
a bottom shell, having the two outflow holes formed therein, being connected to the top shell.

6. The dust-collecting module of claim 5, wherein the two outflow holes are corresponding to each other.

7. The dust-collecting module of claim 2, wherein each blade used in the impeller is a blade selected from the group consisting of airfoil blades of signal-blade design and airfoil blades of dual-blade design.

8. The dust-collecting module of claim 2, wherein a filtering device is arranged between the centrifugal fan apparatus and the through hole.

9. The dust-collecting module of claim 2, wherein the dust-collecting lid is further comprised of a roller.

10. The dust-collecting module of claim 9, wherein the dust-collecting lid is further comprised of a brush.

11. The dust-collecting module of claim 2, wherein the two outflow holes are corresponding to each other.
